(19) United States
(12) Patent Application Publication
(10) Pub. No.: US 2025/0259156 A1
(43) Pub. Date: Aug. 14, 2025

(54) INTERACTIVE POINT OF TRANSACTION DEVICES

(71) Applicant: JPMORGAN CHASE BANK, N.A., New York, NY (US)

(72) Inventor: Christopher ROTSAERT, Tampa, FL (US)

(21) Appl. No.: 19/052,777

(22) Filed: Feb. 13, 2025

Related U.S. Application Data
(60) Provisional application No. 63/552,920, filed on Feb. 13, 2024.

(51) Int. Cl. G06Q 20/20; G06F 3/01; G06V 40/60

(52) U.S. Cl. CPC G06Q 20/206; G06F 3/011; G06V 40/67

(57) ABSTRACT

Interactive point of transaction devices are disclosed. A method may include: (1) detecting, by a computer program executed by an interactive point of transaction device, a biometric or a transaction device proximate to the interactive point of transaction device; (2) providing, by the computer program and on the interactive point of transaction device, instructions for presenting the biometric or the transaction device to a target sensor on the interactive point of transaction device; (3) providing, by the computer program, feedback on the presentation of the biometric or the transaction device to the target sensor on a display; (4) capturing, by the computer program and using the target sensor, information from the biometric or the transaction device; and (5) providing, by the computer program, instructions for removing the biometric or the transaction device from the interactive point of transaction device.

### RELATED APPLICATIONS

This application claims priority to, and the benefit of, U.S. Provisional Patent Application Ser. No. 63/552,920, filed Feb. 13, 2024, the disclosure of which is hereby incorporated, by reference, in its entirety.

### BACKGROUND OF THE INVENTION

### 1. Field of the Invention

Embodiments are generally directed to interactive point of transaction devices.

### 2. Description of the Related Art

Payments by biometrics are an emerging technology. Cameras and other sensors may capture a customer's biometrics, such as a face, palm, fingerprint, voice, etc. and may use those biometrics to identify a payment device and to authorize a transaction. Due to the number of different ways to accept a payment, such as swipe, dip, tap, mobile, and biometrics, the customer may have difficulty properly aligning a payment card, a mobile device, or the biometric to be captured with the appropriate sensor. In addition, a point of transaction device including these separate readers will be large and unwieldly.

### SUMMARY OF THE INVENTION

Interactive point of transaction devices are disclosed. In one embodiment, a method may include: (1) detecting, by a computer program executed by an interactive point of transaction device, a biometric or a transaction device proximate to the interactive point of transaction device; (2) providing, by the computer program and on the interactive point of transaction device, instructions for presenting the biometric or the transaction device to a target sensor on the interactive point of transaction device; (3) providing, by the computer program, feedback on the presentation of the biometric or the transaction device to the target sensor on a display; (4) capturing, by the computer program and using the target sensor, information from the biometric or the transaction device; and (5) providing, by the computer program, instructions for removing the biometric or the transaction device from the interactive point of transaction device.

In one embodiment, the target sensor may include a camera, a wireless reader, or a touch-sensitive area on the interactive point of transaction device.

In one embodiment, the feedback may include an image or a video of the biometric or the transaction device being presented to the target sensor.

In one embodiment, the method may also include: sensing, by a proximity sensor in the interactive point of transaction device, a location of the biometric or the transaction device relative to the interactive point of transaction device, and the feedback may be based on the location.

In one embodiment, the step of providing instructions for presenting the biometric or the transaction device to a target sensor on the interactive point of transaction device may include: illuminating, by the computer program, an area on the interactive point of transaction device that is proximate to the target sensor.

In one embodiment, the step of illuminating an area proximate to the target sensor may include illuminating a boundary area comprising one or more light emitting diodes and one or more graphical elements on the display, wherein the graphical elements are displayed to provide continuity with the one or more light emitting diodes.

In one embodiment, the illumination of the boundary area may be dynamic and changes during the course of the presentation.

According to another embodiment, an interactive point of transaction device may include: a controller; a display; a target sensor; a plurality of light emitting diodes (LEDs); and a memory storing a computer program, wherein the computer program may be configured to detect a biometric or a transaction device proximate to the interactive point of transaction device; to provide, on the interactive point of transaction device, instructions for presenting the biometric or the transaction device to a target sensor on the interactive point of transaction device; to provide feedback on the presentation of the biometric or the transaction device to the target sensor on a display; to capture, using the target sensor, information from the biometric or the transaction device; and to provide instructions for removing the biometric or the transaction device from the interactive point of transaction device.

In one embodiment, the target sensor may include a camera or a wireless reader.

In one embodiment, the target sensor may include a touch-sensitive area on the interactive point of transaction device.

In one embodiment, the feedback may include an image or a video of the biometric or the transaction device being presented to the target sensor.

In one embodiment, the interactive point of transaction device may include a proximity sensor that may be configured to sense a location of the biometric or the transaction device relative to the interactive point of transaction device, and the feedback may be based on the location.

In one embodiment, computer program provides instructions for presenting the biometric or the transaction device to a target sensor on the interactive point of transaction device by illuminating a boundary area comprising one or more light emitting diodes and one or more graphical elements on the display, wherein the graphical elements are displayed to provide continuity with the one or more light emitting diodes.

In one embodiment, the illumination of the boundary area may be dynamic and changes during the course of the presentation.

According to another embodiment, a non-transitory computer readable storage medium may include instructions stored thereon, which when read and executed by one or more computer processors, cause the one or more computer processors to perform steps comprising: detecting a biometric or a transaction device proximate to an interactive point of transaction device; providing instructions for presenting the biometric or the transaction device to a target sensor on the interactive point of transaction device; providing feedback on the presentation of the biometric or the transaction device to the target sensor on a display; capturing, using the target sensor, information from the biometric or the transaction device; and providing instructions for removing the biometric or the transaction device from the interactive point of transaction device.

In one embodiment, the target sensor may include a camera, a wireless reader, or a touch-sensitive area on the interactive point of transaction device.

In one embodiment, the feedback may include an image or a video of the biometric or the transaction device being presented to the target sensor.

In one embodiment, the non-transitory computer readable storage medium may also include instructions stored thereon, which when read and executed by the one or more computer processors, cause the one or more computer processors to perform steps comprising: sensing, using a proximity sensor, a location of the biometric or the transaction device relative to the interactive point of transaction device, and the feedback may be based on the location.

In one embodiment, the step of providing instructions for presenting the biometric or the transaction device to a target sensor on the interactive point of transaction device comprise instructions stored thereon, which when read and executed by the one or more computer processors, cause the one or more computer processors to perform steps comprising: illuminating an area on the interactive point of transaction device that is proximate to the target sensor.

In one embodiment, the step of illuminating an area proximate to the target may include instructions stored thereon, which when read and executed by the one or more computer processors, cause the one or more computer processors to perform steps comprising illuminating a boundary area comprising one or more light emitting diodes and one or more graphical elements on the display, wherein the graphical elements are displayed to provide continuity with the one or more light emitting diodes, and wherein the illumination of the boundary area may be dynamic and changes during the course of the presentation.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a front view of an interactive point of transaction device according to an embodiment;

FIG. 2 illustrates a side view of an interactive point of transaction device according to an embodiment; and

FIG. 3 depicts a method of operating an interactive point of transaction device according to an embodiment.

### DETAILED DESCRIPTION OF PREFERRED EMBODIMENTS

Interactive point of transaction devices are disclosed.

Embodiments may combine a Light Emitting Diode (LED) strip function with a strip prompted on a display to create a “landing area” for receiving a tap or a biometric. Embodiments may include one or more camera centered on the landing area and another located on the edge of the screen.

The LEDs and display for the landing area may be dynamic (e.g., may be turned on, may be turned off, may have different colors, etc.), may provide animation, etc. The dynamic nature may be used to provide guidance for the end user to properly locate a card, mobile device, biometric, etc.

In embodiments, the landing area may accommodate different functions to adjust with different positions of combined readers (e.g., NFC, palm, QR code, face, etc.).

The display may provide feedback to the user to guide the user to position the payment device, the biometric, the mobile device, etc. to the correct position. In one embodiment, the device may request the user to identify the type of payment (e.g., swipe, dip, swipe, QR code, biometric, etc.) and may then provide guidance. In another embodiment, the device may identify the type of payment based on the customer's prior payments, by using the camera, etc. Once the payment type is identified, it may then provide guidance.

In one embodiment, the device may include a proximity sensor that may control the display of dynamic content.

In one embodiment, the proximity sensor may be used to power on the NFC transceiver, cameras, etc. so that they are only active when a target is within a certain distance of the device. For example, the NFC transceiver may only be powered on when an object is within 6 cm of the NFC transceiver.

In addition, embodiments may use a Red-Green-Blue (RGB) camera in conjunction with the proximity sensor to control the display of the dynamic content.

Embodiments may further use infrared cameras that may be used, for example, for vein mapping.

In embodiments, the display may be used to create illumination for better capture of images.

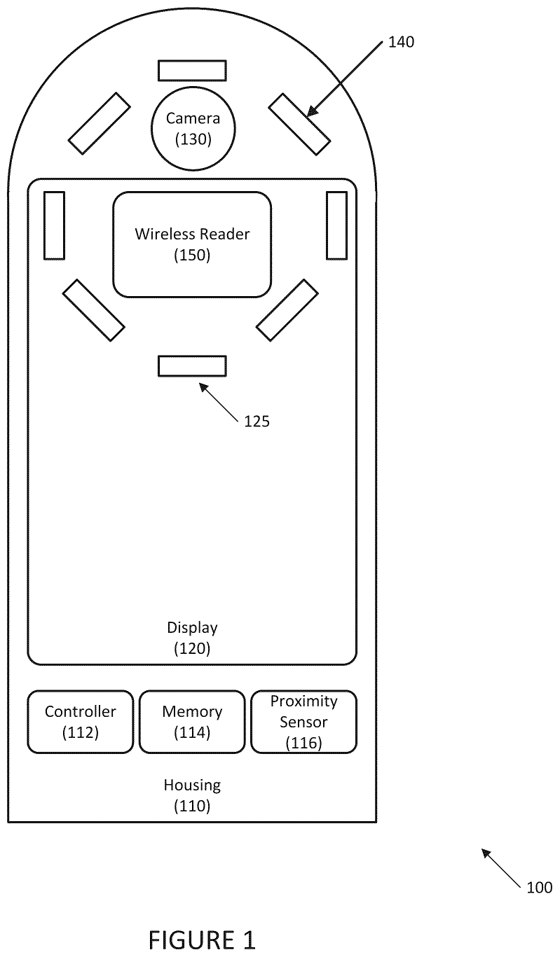

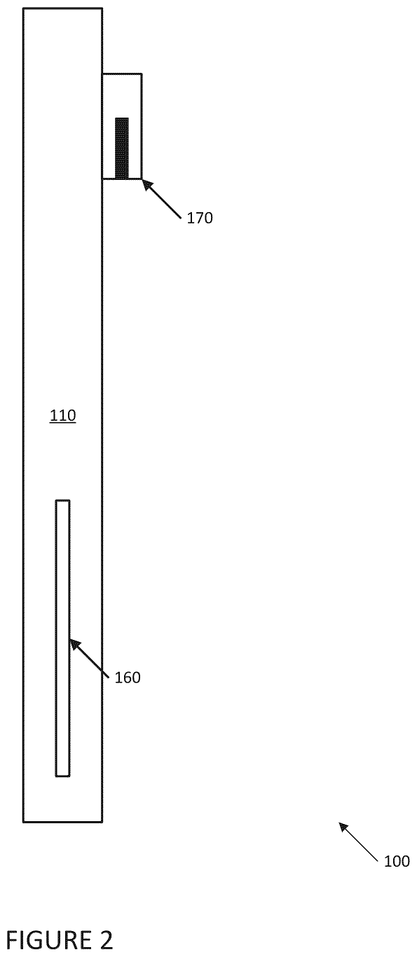

Referring to FIGS. 1 and 2, an exemplary interactive point of transaction device is disclosed according to an embodiment. Device 100 may include housing 110, controller 112, memory 114, display 120, camera 130, LEDs 140, wireless reader 150, card slot 160, and magnetic stripe reader 170.

Housing 110 may be made of plastic, metal, combinations thereof, etc. and may provide a structure for housing components.

Controller 112 may be a microprocessor-based controller that may control the operation of device 100. Controller 112 may execute one or more computer programs stored in memory 114.

Display 120 may display information, such as instructions, transaction status, suggestions, etc. Display 120 may be a touch-based display.

In one embodiment, display 120 may display graphical elements 125, such as virtual LEDs, that may be displayed in conjunction with LEDs 140 to provide a target for a user to present a wireless-enabled device (e.g., a smart phone, a smart watch, a credit or debit card, etc.) to wireless reader 150. The positioning and display of graphical elements 125 may provide continuity with LEDs 140.

Graphical elements 125 and/or LEDs 140 may provide a status of data transfer from a wireless-enabled device to wireless reader 150 by, for example, sequentially illuminating as data is transferred.

Camera 130 may capture images of a user for biometric authentication. For example, camera 130 may capture images of the user's face, palm, finger(s), iris, etc.

Camera 130 may also capture images of a wireless-enabled device that may be presented to wireless reader 150, or of a biometric being presented to camera 130, and may provide the images to controller 112. If the wireless-enabled device or the biometric is not being presented properly, controller 112 may cause display 120 to output a message to provide instructions on how to present the wireless-enabled device or the biometric.

Camera 130 may also receive machine-readable codes, such as Quick Response (QR) codes on paper or displayed on a display of a transaction device, may detect the presence of a biometric, a device, etc.

Camera 130 may include one or more Red-Green-Blue (RGB) cameras, infra-red (IR) cameras, etc. In one embodiment, a RGB camera may be the primary source of information, and an IR may be used in low light environments, for liveness detection, etc. For example, when a palm biometric is presented, the RGB camera may capture palm information, and the IR camera may capture palm vein information.

Proximity sensor 116 may sense the presence of a wireless-enabled device or a biometric relative to device 100, and may provide the information to controller 112. Controller 112 may cause display 120 to output a message to provide instructions on how to present the wireless-enabled device or the biometric.

Proximity sensor 116 may detect a time of flight between a signal emitted by proximity sensor 116 and an object, such as a biometric, a card, etc. For example, proximity sensor 116 may emit, or detect the emission, of a signal (e.g., RF, light, sound, etc.) and may detect the return of the signal to interactive point of transaction device 100. It may then calculate the time of flight (e.g., the round trip time for the signal) and may determine the distance between the object and interactive point of transaction device 100.

In embodiment, display 120 may further provide video or images as feedback to the user. For example, display 120 may provide feedback on the biometric (e.g., an image of video of the face) and guidance (e.g., a target for capturing the biometric). It may also provide offers, advertisements, etc.

Card slot 160 may receive a portion of a card, such as a credit card, debit card, etc., with an EMV chip, and may read card information from the EMV chip.

Magnetic stripe reader 170 may read card information from a magnetic stripe on a card.

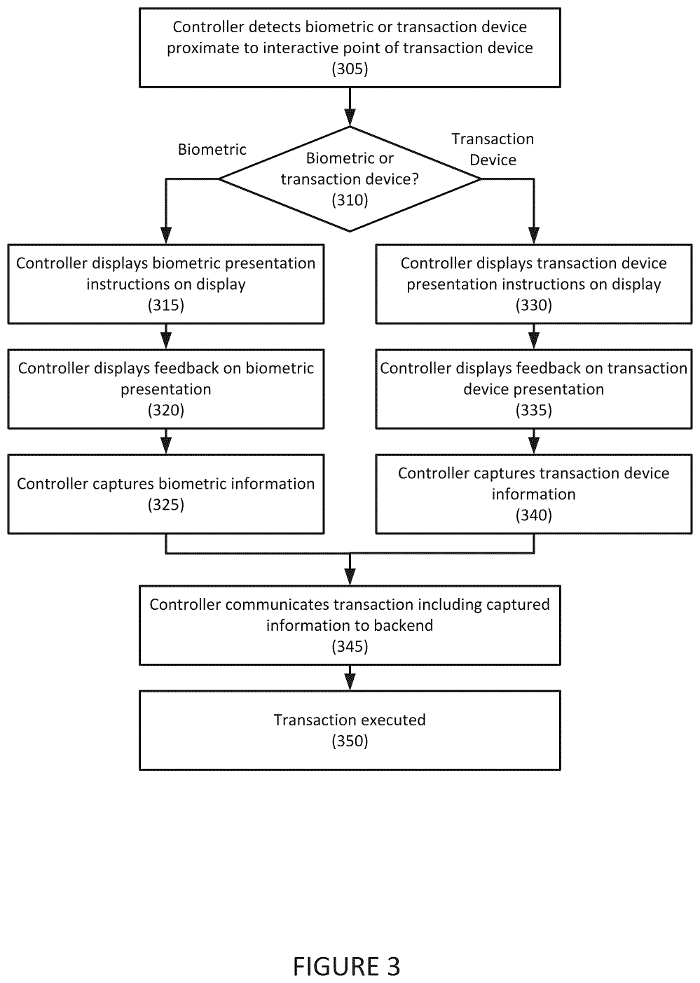

Referring to FIG. 3, a method for controlling the operation of an interactive point of transaction device is provided according to an embodiment.

In step 305, an interactive point of transaction device may detect a biometric (e.g., a human body part, such as a finger, a palm, a face, etc.) or a transaction device (e.g., an electronic wallet equipped electronic device, an NFC-enabled credit card, a wireless payment token, a QR code, etc.) that is proximate to the interactive point of transaction device. For example, a controller on the interactive point of transaction device executing a computer program may use a proximity sensor, a camera, a RF transceiver, etc. to detect the presence of a human or a transaction device within a certain distance of the interactive point of transaction device. The distance may be configurable, and may be set such that it is likely to detect the presence of a human or transaction device as part of conducting a transaction.

In step 310, the controller may determine whether it detected a biometric or a transaction device. For example, the controller may determine whether it received a RF signal, or it may use an image from the camera to determine what was sensed.

If the controller determines that it sensed a biometric, in step 315, the controller may display biometric presentation instructions on a display. For example, the controller may display instructions on where the user should present one or more biometrics, such as a finger, a palm, a face, an eye, etc. so that the biometric may be received.

In one embodiment, a target for receiving the biometric (e.g., a camera, a touch-sensitive area, etc.), or an area proximate to the target, may be illuminated for the user. For example, the controller may illuminate LEDs and/or display graphical elements, such as virtual LEDs, to identify the target for the user. The illumination may identify the boundaries for the target that receives the biometric.

In step 320, the controller may display feedback on the biometric presentation. In one embodiment, the sensors on the interactive point of transaction device may sense data from the biometric, and the controller may determine if the biometric is being presented to the target. The controller may display instructions to the user based on the sensing to guide the user to present the biometric to the target.

In one embodiment, the controller may display video captured by a camera near the target to provide feedback to the user.

In one embodiment, the illumination of the target area may be dynamic and may change during the course of the presentation. For example, the color and/or intensity of the illumination (e.g., the LEDs and/or the graphical elements) may change as the biometric is being presented, in proper position to be read, when the biometric is successfully captured, and/or when there is a failure capturing the biometric. This provides the user with feedback on the process.

In step 325, once the biometric is presented, the sensing device may capture biometric information from the user. For example, a camera or a touch-sensitive device may capture the biometric. Once the biometric is captured, the controller may inform the user that the biometric may be removed.

In step 345, the controller communicates transaction including captured information to a backend, such as a backend for an acquirer or an issuer, so that, in step 350, the transaction can be completed.

If the controller determines that it sensed a transaction device, in step 330, the controller may display transaction device presentation instructions on display. For example, the controller may display instructions on where the user should present the transaction device, such as near a NFC reader.

In one embodiment, a target for interacting with the transaction device, such as a wireless reader (e.g., a NFC reader), or an area proximate to the target, may be illuminated for the user. For example, the controller may illuminate LEDs and/or display graphical elements, such as virtual LEDs, to identify the target for the user. The illumination may identify the boundaries for the target that receives the transaction device.

In step 335, the controller may display feedback on the transaction device presentation. For example, once the transaction device is close enough to be read, the controller may instruct the user to hold the transaction device in place until the data is read. As the data is read, status LEDs may illuminate. Once all data is read, the controller may instruct the user to remove the transaction device from the target.

In one embodiment, the illumination of the target area may be dynamic and may change during the course of the presentation. For example, the color and/or intensity of the illumination (e.g., the LEDs and/or graphical elements) may change as the transaction device is being presented, in proper position to be read, when the data is read successfully, and/or when there is a failure in reading the data. This provides the user with feedback on the process.

In step 340, the sensing device may capture data from the transaction device. For example, a wireless reader, such as a RF reader, may read information from the transaction device. Once all data is read, the controller may instruct the user to remove the transaction device from the target.

If the information cannot be read, the controller on the interactive point of transaction device may display instructions to present the transaction device in a different manner, such as dipping or swiping.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity, i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
detecting, by a computer program executed by an interactive point of transaction device, a biometric or a transaction device proximate to the interactive point of transaction device;
providing, by the computer program and on the interactive point of transaction device, instructions for presenting the biometric or the transaction device to a target sensor on the interactive point of transaction device;
providing, by the computer program, feedback on the presentation of the biometric or the transaction device to the target sensor on a display;
capturing, by the computer program and using the target sensor, information from the biometric or the transaction device; and
providing, by the computer program, instructions for removing the biometric or the transaction device from the interactive point of transaction device.

2. The method of claim 1, wherein the target sensor comprises a camera, a wireless reader, or a touch-sensitive area on the interactive point of transaction device.

3. The method of claim 1, wherein the feedback comprises an image or a video of the biometric or the transaction device being presented to the target sensor.

4. The method of claim 1, further comprising:
sensing, by a proximity sensor in the interactive point of transaction device, a location of the biometric or the transaction device relative to the interactive point of transaction device;
wherein the feedback is based on the location.

5. The method of claim 1, wherein the step of providing instructions for presenting the biometric or the transaction device to a target sensor on the interactive point of transaction device comprises:
illuminating, by the computer program, an area on the interactive point of transaction device that is proximate to the target sensor.

6. The method of claim 5, wherein the step of illuminating an area proximate to the target sensor comprises illuminating a boundary area comprising one or more light emitting diodes and one or more graphical elements on the display, wherein the graphical elements are displayed to provide continuity with the one or more light emitting diodes.

7. The method of claim 6, wherein the illumination of the boundary area is dynamic and changes during the course of the presentation.

8. An interactive point of transaction device, comprising:
a controller;
a display;
a target sensor;
a plurality of light emitting diodes (LEDs); and
a memory storing a computer program, wherein the computer program is configured to detect a biometric or a transaction device proximate to the interactive point of transaction device; to provide, on the interactive point of transaction device, instructions for presenting the biometric or the transaction device to a target sensor on the interactive point of transaction device; to provide feedback on the presentation of the biometric or the transaction device to the target sensor on a display; to capture, using the target sensor, information from the biometric or the transaction device; and to provide instructions for removing the biometric or the transaction device from the interactive point of transaction device.

9. The interactive point of transaction device of claim 8, wherein the target sensor comprises a camera or a wireless reader.

10. The interactive point of transaction device of claim 8, wherein the target sensor comprises a touch-sensitive area on the interactive point of transaction device.

11. The interactive point of transaction device of claim 8, wherein the feedback comprises an image or a video of the biometric or the transaction device being presented to the target sensor.

12. The interactive point of transaction device of claim 8, further comprising:
a proximity sensor that is configured to sense a location of the biometric or the transaction device relative to the interactive point of transaction device;
wherein the feedback is based on the location.

13. The interactive point of transaction device of claim 8, wherein computer program provides instructions for presenting the biometric or the transaction device to a target sensor on the interactive point of transaction device by illuminating a boundary area comprising one or more light emitting diodes and one or more graphical elements on the display, wherein the graphical elements are displayed to provide continuity with the one or more light emitting diodes.

14. The interactive point of transaction device of claim 13, wherein the illumination of the boundary area is dynamic and changes during the course of the presentation.

15. A non-transitory computer readable storage medium, including instructions stored thereon, which when read and executed by one or more computer processors, cause the one or more computer processors to perform steps comprising:
detecting a biometric or a transaction device proximate to an interactive point of transaction device;
providing instructions for presenting the biometric or the transaction device to a target sensor on the interactive point of transaction device;
providing feedback on the presentation of the biometric or the transaction device to the target sensor on a display;
capturing, using the target sensor, information from the biometric or the transaction device; and
providing instructions for removing the biometric or the transaction device from the interactive point of transaction device.

16. The non-transitory computer readable storage medium of claim 15, wherein the target sensor comprises a camera, a wireless reader, or a touch-sensitive area on the interactive point of transaction device.

17. The non-transitory computer readable storage medium of claim 15, wherein the feedback comprises an image or a video of the biometric or the transaction device being presented to the target sensor.

18. The non-transitory computer readable storage medium of claim 15, further including instructions stored thereon, which when read and executed by the one or more computer processors, cause the one or more computer processors to perform steps comprising:
sensing, using a proximity sensor, a location of the biometric or the transaction device relative to the interactive point of transaction device;
wherein the feedback is based on the location.

19. The non-transitory computer readable storage medium of claim 18, wherein the step of providing instructions for presenting the biometric or the transaction device to a target sensor on the interactive point of transaction device comprise instructions stored thereon, which when read and executed by the one or more computer processors, cause the one or more computer processors to perform steps comprising:
illuminating an area on the interactive point of transaction device that is proximate to the target sensor.

20. The non-transitory computer readable storage medium of claim 19, wherein the step of illuminating an area proximate to the target comprises instructions stored thereon, which when read and executed by the one or more computer processors, cause the one or more computer processors to perform steps comprising illuminating a boundary area comprising one or more light emitting diodes and one or more graphical elements on the display, wherein the graphical elements are displayed to provide continuity with the one or more light emitting diodes, and the illumination of the boundary area is dynamic and changes during the course of the presentation.
